(19) United States
(12) Patent Application Publication
(10) Pub. No.: US 2003/0021580 A1
(43) Pub. Date: Jan. 30, 2003

(54) Method and apparatus for coupling terminal equipment to a node in an optical communications network

(75) Inventor: Craig A. Matthews, Tinton Falls, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Photoris, Inc.

(21) Appl. No.: 09/908,457

(22) Filed: Jul. 18, 2001

(51) Int. Cl. G02B 6/00; H04B 10/12

(52) U.S. Cl. 385/147; 359/109

(57) ABSTRACT

An apparatus for automatically discovering a cable interconnection topology in an optical communications network between an optical network node and a CSI expansion shelf employs a memory module attached to each end of a fiber optic cable connecting the node and the shelf. A connector houses a rewritable memory module that stores identification information regarding the type of cable and is capable of storing node and port identification regarding the port to which the end to which the memory module is attached, as well as the node and port identification about the port to which the other end of the cable to which the memory module is attached. The port and node connected information is then broadcast via the control channel to all appropriate entities, such as the master node, or other entity maintaining network topology information. Optionally, a presence indicator causes an interrupt in the port equipment when the cable is initially connected to the port and if and when the cable is disconnected from the port.

### BACKGROUND OF THE INVENTION

The present invention relates generally to methods and apparatuses for coupling terminal equipment to a node in optical communications equipment, and more particularly to a method and apparatus for coupling terminal equipment to a node in optical communications equipment in an automatic manner.

At the terminal side of an optical communications network, entering the customer premises, a CSI (Customer Service Interface) pack converts the customer's local area network (LAN) interface signal to a signal that can be transmitted in a Dense Wave Division Multiplexing (DWDM) system. The CSI pack is coupled via a cable, such as a fiber optic cable, to an optical network node (ONN) in the optical communications network. Each CSI card typically operates on a single channel or wavelength of the DWDM system. An optical network node includes CSI expansion shelves that can each hold up to 16 CSIs. There are many different types of CSI packs, e.g., at least 32 types, to which an optical network node may be connected, each of which may transmit in a specific frequency band, also referred to as a specific wavelength. From the system perspective, the controllers need to know what CSIs are plugged into what slot. From the cable perspective, the controllers need to know what cables on the CSI expansion shelf are plugged into what ports on the main or parent shelves, so that data traffic on the ring is not disrupted. If the customer does not cable things correctly between shelves, then when a CSI is activated, it could corrupt a functioning part of the system. Thus, all of the controllers around the ring need to communicate their topology to each other so that data flow can be established properly.

The present invention is therefore directed to the problem of developing a method and apparatus for automatically discovering the topology of an optical communications network between a node in the network and customer equipment on the terminal side.

### SUMMARY OF THE INVENTION

The present invention solves these and other problems by, inter alia, providing an automated technique for communicating configuration information between the node and the customer equipment. To do so, according to one aspect of the present invention, an identifying module is directly coupled to the cable, which contains certain configuration information about the cable to which the node is coupled.

In accordance with one aspect of the invention, a method is provided for automatically discovering a cable interconnection between an optical network node and a CSI expansion shelf. The method begins by coupling an identifying module to each end of a cable connecting a port on the optical network node and a port on the CSI expansion shelf. Next, a cable identification is stored in each of the identifying modules.

In accordance with another aspect of the invention, an apparatus is provided for enabling rapid discovery of a cable connection topology in an optical communications network between a node in the optical communications network and a CSI expansion shelf. The apparatus includes a cable to be connected between the node and the CSI expansion shelf. The cable has a first end and a second end. A first identifying module is coupled to the first end of a cable and a second identifying module is coupled to the second end of the cable. The first and second identifying modules store identification information regarding the cable.

### BRIEF DESCRIPTION OF THE DRAWINGS

FIG. 1 depicts an exemplary embodiment of a cable interconnecting node to a CSI expansion shelf in accordance with the present invention.

FIG. 2 shows a flowchart of an exemplary embodiment of a method for automatically discovering the port interconnections between an Optical Network Node and a CSI expansion shelf.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention discloses a technique for identifying a fiber cable attached to a node in an optical communications network such as a DWDM system. In this system, one shelf, called the main shelf, is connected to the Wide Area Network (WAN) fiber or fibers for inter-node transmission. Other shelves, called CSI expansion shelves, connect via fibers to the main shelf to hold additional CSI packs that transmit and receive on certain channel wavelengths. In short, a cable connects an optical network node to a CSI expansion shelf.

Assume that the cable is connected to a particular port, e.g., port 10, of the optical network node (ONN). According to one aspect of the present invention, a identifying module, such as an EEPROM, is directly coupled to the cable. The ONN reads the contents of the identifying module and identifies the cable as “CABLE A”. This cable (CABLE A) is then connected to a particular port, e.g., port 8, in the CSI expansion shelf. The ONN informs the CSI expansion shelf that the cable (CABLE A) is connected to which port on ONN, e.g., port 10. Similarly, the CSI expansion shelf informs the ONN as to which port, e.g., port 8, the cable (CABLE A) is connected in the CSI expansion shelf.

According to one aspect of the present invention, an identification (ID) plug is coupled to the cable that identifies the type of cable. The ID plug can be molded to or otherwise attached to the fiber connectors. The ID plug, for example, could be attached via a harness at both ends of the cable.

A controller in the ONN reads the ID plug coupled to each port, and tells the ID plug at the other end to what port it is coupled. Thus, both ends know the port to which the other end is coupled. Moreover, this information can be stored in the memory of the ID plug, i.e., in addition to the cable identification information. This enables the topology of this portion of the network to be easily and automatically discovered.

The ID plug could be as simple as a shorting block (e.g., connecting pins together in a pattern to indicate some ID code) or as complex as an EEPROM with some embedded code. Preferably, both ends of the cable would have the same ID code.

The ID plug could be advantageously programmed at the factory, or modified by a technician in the field. To aid the software (avoid pulling these ID plugs) the plug could ground a lead to indicate “presence.” This presence could be and interrupt to the system so that the controller would know both when a cable is installed and removed.

The connection pinout for and I²C Serial EEPROM could be, for example:

| Pin | Connection |
|---|---|
| 1 | VCC |
| 2 | GND |
| 3 | Data (I²C) |
| 4 | Clock (I²C) |
| 5 | A2 (I²C) |
| 6 | Al (I²C) |
| 7 | A0 (I²C) |
| 8 | WP (I²C write protect) |
| 9 | Presence |

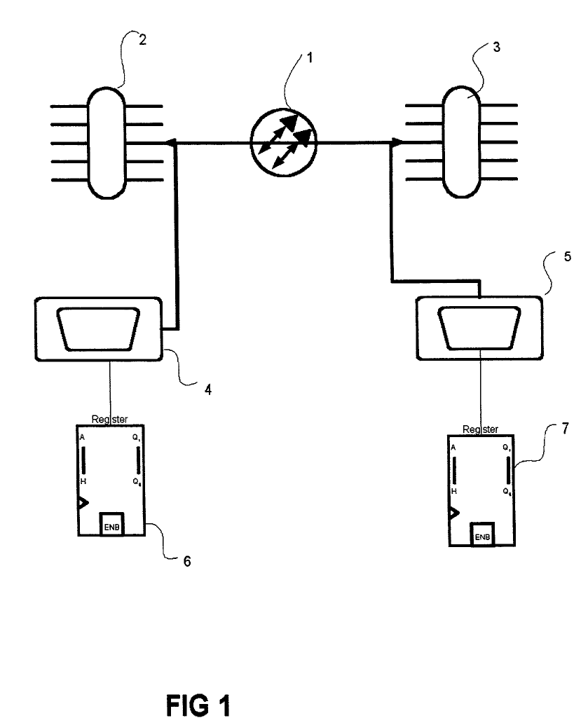

Shown in FIG. 1 is an exemplary block diagram of an apparatus according to one aspect of the present invention. A fiber optic cable 1 connects a node in an optical network 2 to a CSI expansion shelf 3. At each end of cable 1 is a connector 4, 5 attached to the cable 1. Each connector 4, 5 includes an identifying module such as memory module 6, 7, respectively. If the identifying module is a memory module, the memory module could either be a read only (ROM) or a rewritable memory (such as a RAM). Each memory module identifies the type of cable and is capable of storing the identification of the node and port to which is attached the end of the cable that includes the module, as well as the identification of the node and port to which the other end of the cable is attached. There may be a direct connection in the cable 1 between the memory modules 6, 7 for this purpose, or this information may be transferred to one of the processors in the port to which the cable is connected, and then updated from that end.

The port and node connected information is then broadcast via a control channel to all appropriate entities, such as the master node, or other entity maintaining network topology information.

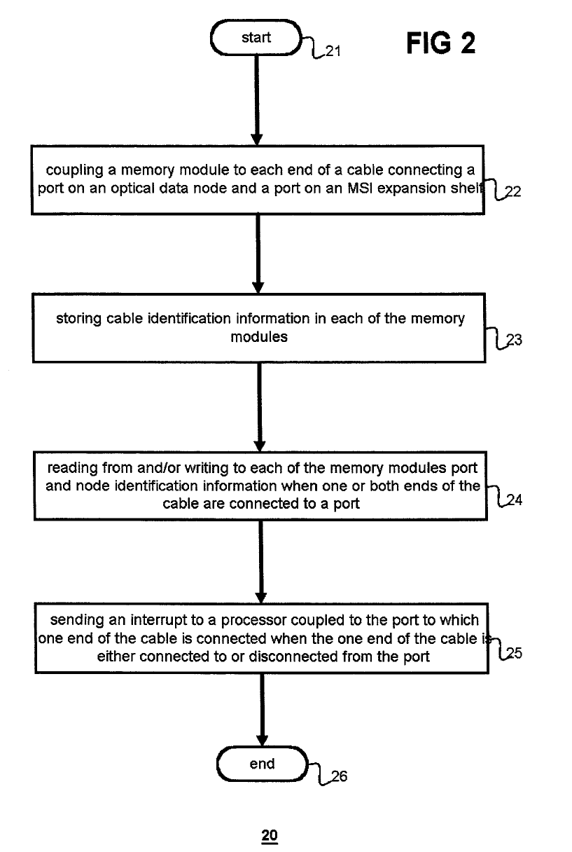

FIG. 2 shows a flowchart of an exemplary embodiment of a method 20 according to another aspect of the present invention for automatically discovering the port interconnections between an Optical Network node and a CSI expansion shelf. First, a memory module is coupled to each end of a fiber optic cable connecting a port on the optical network node and a port on the CSI expansion shelf 22. Next, cable identification information is stored in each of the memory modules 23. This information could be stored in the factory during the cable manufacturing process. For example, each cable could be programmed with a unique serial number at the factory. The controller would then simply read the stored identification information in the devices. The controller could then optionally write the connected port information back into the EEPROM. The process could be initiated when one or more ends of the cable are connected to a port in the Optical Network node or a port in the CSI expansion shelf. The read out memory contents then can be advertised over a control channel, for example, and then paired together from the other end. The memory modules can also be updated with the port and node identification information 24, if desired. Optionally, a presence indicator (e.g., a grounded lead to a microprocessor in the port equipment) causes an interrupt in the port equipment when the cable is initially connected to the port and if and when the cable is disconnected from the port 25. This ensures network integrity at all times.

Alternatively, the controller could advertise the discovered cable serial numbers, and then a cable topology can be determined from that report. By aggregating all of the advertised discovered cable serial numbers, one could piece together the complete cable topology.

In another embodiment of the invention, electrical wires could travel the length of the fiber so an electrical connection exists between the ONN and the CSI expansion shelves, in addition to a fiber optical connection. In that case, cable topology could be determined by having the ONN close an electrical connection or make an electrical signal on a particular port, and then asking (or otherwise reporting) what other port in the system “sees” the activity.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and protocols, any formats and protocols will suffice. Moreover, while some of the embodiments describe specific embodiments of ONNs, others apply. Furthermore, these examples should not be interpreted to limit the modifications and variations of the invention covered by the claims but are merely illustrative of possible variations.

What is claimed is:

1. A method for automatically discovering a cable interconnection between an optical network node and a CSI expansion shelf, comprising:
coupling an identifying module to each end of a cable connecting a port on the optical network node and a port on the CSI expansion shelf; and
storing a cable identification in each of the identifying modules.

2. The method according to claim 1, further comprising reading from the identifying module at a first end of the cable a first port to which said first end of the cable is connected upon connecting said first end to the first port.

3. The method according to claim 1, further comprising writing in the identifying module at a first end of the cable a first port to which said first end of the cable is connected upon connecting said first end to the first port.

4. The method according to claim 2, further comprising reading from the identifying module at the second end of the cable a second port to which said second end of the cable is connected upon connecting said second end to the second port.

5. The method according to claim 3, further comprising writing in the identifying module at the second end of the cable a second port to which said second end of the cable is connected upon connecting said second end to the second port.

6. The method according to claim 2, further comprising reading from the identifying module at the second end of the cable a first port to which said first end of the cable is connected upon connecting said first end to the first port.

7. The method according to claim 3, further comprising writing in the identifying module at the second end of the cable a first port to which said first end of the cable is connected upon connecting said first end to the first port.

8. The method according to claim 4, further comprising writing in the identifying module at the first end of the cable a second port to which said second end of the cable is connected upon connecting said second end to the second port.

9. The method according to claim 3, further comprising writing in the identifying module at the first end a first node associated with said first port.

10. The method according to claim 9, further comprising writing in the identifying module at the second end a first node associated with said first port.

11. The method according to claim 4, further comprising writing in the identifying module at the first end a first node associated with said first port.

12. The method according to claim 11, further comprising writing in the identifying module at the second end a second node associated with said second port.

13. The method according to claim 5, further comprising writing in the identifying module at the first end a first node associated with said first port and writing in the identifying module at the second end the first node associated with said first port.

14. The method according to claim 13, further comprising writing in the identifying module at the second end a second node associated with said second port and writing in the identifying module at the first end the second node associated with the second port.

15. The method according to claim 3, further comprising sending an interrupt to a processor coupled to the first port when the first end of the cable is disconnected from the first port.

16. The method according to claim 15, further comprising updating the identifying module in the second end when the first end is disconnected from the first port to indicate that the first end is no longer connected to the first port.

17. The method according to claim 3, further comprising sending an interrupt to a processor coupled to the first port when the first end of the cable is initially connected to the first port.

18. An apparatus for enabling rapid discovery of a cable connection topology in an optical communications network between a node in the optical communications network and a CSI expansion shelf, comprising:
a cable for connecting between the node and the CSI expansion shelf, said cable having a first end and a second end;
a first memory module coupled to the first end of a cable; and
a second memory module coupled to the second end of the cable, wherein said first and second memory module store identification information regarding the cable.

19. The apparatus according to claim 15, wherein said first and second memory modules are rewritable.

20. The apparatus according to claim 19, wherein said first and second memory modules are capable of accepting data identifying a port to which each of said first and second ends of the cable are coupled.

21. The apparatus according to claim 20, wherein said first and second memory modules are capable of accepting data identifying a port and a node to which each of said first and second ends of the cable are coupled.

22. The apparatus according to claim 18, wherein said first and second memory modules further comprise a presence connection, which when disconnected from a port to which it is connected causes an interrupt to be sent to a processor to which the port is coupled.

23. The apparatus according to claim 18, wherein said first and second memory modules further comprise a present connection, which when initially connected to a port causes an interrupt to be sent to a processor to which the port is coupled.

24. A method for determining cable topology between customer terminal equipment and an optical network node in an optical communications network comprising:
providing an electrical connection in a fiber optic cable coupling the customer terminal equipment and the optical network node;
toggling a connection at a terminal end of the electrical connection; and
querying equipment located on an end opposite to the terminal end as to which equipment detected activity related to said toggling.

25. The method according to claim 24, wherein said toggling includes opening or closing said connection.

26. The method according to claim 24, further comprising reporting a result of detecting activity in response to said querying.
